(19) United States
(12) Patent Application Publication
(10) Pub. No.: US 2025/0291888 A1
(43) Pub. Date: Sep. 18, 2025

(54) INFORMATION PROCESSING APPARATUS, INFORMATION PROCESSING METHOD, AND NON-TRANISITORY RECORDING MEDIUM

(71) Applicant: NEC Corporation, Minato-ku, Tokyo (JP)

(72) Inventors: Megumi HASHIMOTO, Tokyo (JP); Toshinobu OGATSU, Tokyo (JP); Yoshihiro KAjIKI, Tokyo (JP); Soichiro ARAKI, Tokyo (JP)

(73) Assignee: NEC Corporation, Minato-ku, Tokyo (JP)

(21) Appl. No.: 18/860,084

(22) PCT Filed: Sep. 4, 2023
(86) PCT No.: PCT/JP2023/032236

§ 371 Date: Oct. 25, 2024

(30) Foreign Application Priority Data
Sep. 9, 2022 (JP) 2022-143820

(51) Int. Cl. G06F 21/32; G06V 40/16; G06V 40/18; G06V 40/19; G06V 40/50

(52) U.S. Cl. CPC G06F 21/32; G06V 40/166; G06V 40/172; G06V 40/19; G06V 40/193; G06V 40/197; G06V 40/50

(57) ABSTRACT

An information processing apparatus includes: a code output unit that outputs a target person code to a target person in at least one of a case where face information on the target person is registered and a case where face authentication of the target person is successful; and an iris information registration unit that registers iris information collected from the target person, in association with identification information capable of identifying the target person and the registered face information on the target person, in a case where the target person code is inputted by the target person when registering the iris information on the target person.

This application is a National Stage Entry of PCT/JP2023/032236 filed on Sep. 4, 2023, which claims priority from Japanese Patent Application 2022-143820 filed on Sep. 9, 2022, the contents of all of which are incorporated herein by reference, in their entirety.

### TECHNICAL FIELD

This disclosure relates to technical fields of an information processing apparatus, an information processing method, and a recording medium.

### BACKGROUND ART

Patent Literature 1 describes a gate apparatus that is configured to set whether or not passing through a gate position is permitted or rejected, when a detection unit, which is configured to detect whether a passerby who is about to pass through the gate position, is a passage allowed person or a passage rejected person, detects presence of a passage allowed person and presence of another person, and that is configured to perform passage control such as “permitting entry of a companion when there is one entry permitted person” when there are a plurality of passersby.

### CITATION LIST

### Patent Literature

Patent Literature 1: JP2000-348227A

### SUMMARY

### Technical Problem

It is an example object of this disclosure to provide an information processing apparatus, an information processing method, and a recording medium that aim to improve the techniques/technologies disclosed in Citation List.

### Solution to Problem

An information processing apparatus according to an example aspect of this disclosure includes: a code output unit that outputs a target person code to a target person in at least one of a case where face information on the target person is registered and a case where face authentication of the target person is successful; and an iris information registration unit that registers iris information collected from the target person, in association with identification information capable of identifying the target person and the registered face information on the target person, in a case where the target person code is inputted by the target person when registering the iris information on the target person.

An information processing method according to an example aspect of this disclosure includes: outputting a target person code to a target person in at least one of a case where face information on the target person is registered and a case where face authentication of the target person is successful; and registering iris information collected from the target person, in association with identification information capable of identifying the target person and the registered face information on the target person, in a case where the target person code is inputted by the target person when registering the iris information on the target person.

A recording medium according to an example aspect of this disclosure is a recording medium on which a computer program that allows a computer to execute an information processing method is recorded, the information processing method including: outputting a target person code to a target person in at least one of a case where face information on the target person is registered and a case where face authentication of the target person is successful; and registering iris information collected from the target person, in association with identification information capable of identifying the target person and the registered face information on the target person, in a case where the target person code is inputted by the target person when registering the iris information on the target person.

### BRIEF DESCRIPTION OF DRAWINGS

FIG. 1 is a block diagram illustrating a configuration of an information processing apparatus according to a first example embodiment.

FIG. 2 is a block diagram illustrating a configuration of an information processing apparatus according to a second example embodiment.

FIG. 3A is a flowchart illustrating a flow of an iris information registration operation of the information processing apparatus according to the second example embodiment.

FIG. 3B is a flowchart illustrating a flow of an iris information registration operation of the information processing apparatus according to the second example embodiment.

FIG. 3C is a flowchart illustrating a flow of an iris information registration operation of the information processing apparatus according to the second example embodiment.

FIG. 4 is a block diagram illustrating a configuration of an information processing apparatus according to a third example embodiment.

FIG. 5A is a flowchart illustrating a flow of an iris information registration operation of the information processing apparatus according to the third example embodiment.

FIG. 5B is a flowchart illustrating a flow of an iris information registration operation of the information processing apparatus according to the third example embodiment.

FIG. 6 is a block diagram illustrating a configuration of an information processing apparatus according to a fourth example embodiment.

FIG. 7 is a flowchart illustrating a flow of an information processing operation of the information processing apparatus according to the fourth example embodiment.

FIG. 8 is a block diagram illustrating a configuration of an information processing apparatus according to a fifth example embodiment.

FIG. 9A is a flowchart illustrating a flow of an entry permission operation for a first target person, of the information processing apparatus according to the fifth example embodiment.

FIG. 9B is a flowchart illustrating a flow of an entry permission operation for a first target person, of the information processing apparatus according to the fifth example embodiment.

FIG. 10A is a flowchart illustrating a flow of an entry permission operation for a second target person, of the information processing apparatus according to the fifth example embodiment.

FIG. 10B is a flowchart illustrating a flow of an entry permission operation for a second target person, of the information processing apparatus according to the fifth example embodiment.

FIG. 11A is a flowchart illustrating a flow of a first entry permission operation for a special treatment target person, of the information processing apparatus according to the fifth example embodiment.

FIG. 11B is a flowchart illustrating a flow of a first entry permission operation for a special treatment target person, of the information processing apparatus according to the fifth example embodiment.

FIG. 12A is a flowchart illustrating a flow of a second entry permission operation for the special treatment target person, of the information processing apparatus according to the fifth example embodiment.

FIG. 12B is a flowchart illustrating a flow of a second entry permission operation for the special treatment target person, of the information processing apparatus according to the fifth example embodiment.

FIG. 13 is a block diagram illustrating a configuration of an information processing apparatus according to a sixth example embodiment.

FIG. 14 is a flowchart illustrating a flow of an authentication related operation of the information processing apparatus according to the sixth example embodiment.

FIG. 15 is a block diagram illustrating a configuration of an information processing apparatus according to a seventh example embodiment.

FIG. 16 is a conceptual diagram illustrating an example of a scene where the information processing apparatus according to the seventh example embodiment is applied.

FIG. 17 is a flowchart illustrating a flow of an authentication related operation of the information processing apparatus according to the seventh example embodiment.

### DESCRIPTION OF EXAMPLE EMBODIMENTS

Hereinafter, an information processing apparatus, an information processing method, and a recording medium according to example embodiments will be described with reference to the drawings.

### 1: First Example Embodiment

An information processing apparatus, an information processing method, and a recording medium according to a first example embodiment will be described. The following describes the information processing apparatus, the information processing method, and the recording medium according to the first example embodiment, by using an information processing apparatus 1 to which the information processing apparatus, the information processing method, and the recording medium according to the first example embodiment are applied.

### 1-1: Configuration of Information Processing Apparatus 1

FIG. 1 is a block diagram illustrating a configuration of the information processing apparatus 1 according to the first example embodiment. As illustrated in FIG. 1, the information processing apparatus 1 includes a code output unit 11 and an iris information registration unit 12.

The code output unit 11 outputs a target person code to a target person in at least one of a case where face information on a face of the target person is registered or a case where face authentication of the target person is successful. The iris information registration unit 12 registers iris information collected from the target person, in association with identification information capable of identifying the target person and the registered face information on the target person, in a case where the target person code is inputted by the target person when registering the iris information on the target person.

### 1-2: Technical Effect of Information Processing Apparatus 1

The information processing apparatus 1 according to the first example embodiment, registers the iris information in association with the identification information and the face information, in the case where the target person code is inputted by the target person when the iris information on the target person is registered. It is therefore possible to reliably associate the iris information on the target person with the information capable of identifying the target person. This can prevent the iris information from being registered by a person who impersonates the target person.

### 2: Second Example Embodiment

Next, an information processing apparatus, an information processing method, and a recording medium according to a second example embodiment will be described. The following describes the information processing apparatus, the information processing method, and the recording medium according to the second example embodiment, by using an information processing apparatus 2 to which the information processing apparatus, the information processing method, and the recording medium according to the second example embodiment are applied.

### 2-1: Configuration of Information Processing Apparatus 2

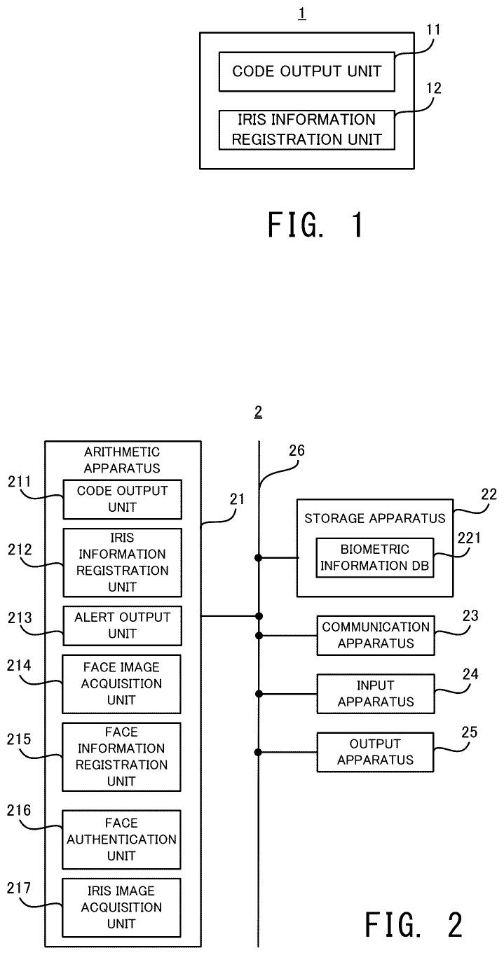

FIG. 2 is a block diagram illustrating the information processing apparatus 2 according to the second example embodiment. As illustrated in FIG. 2, the information processing apparatus 2 includes an arithmetic apparatus 21 and a storage apparatus 22. Furthermore, the information processing apparatus 2 may include a communication apparatus 23, an input apparatus 24, and an output apparatus 25. The information processing apparatus 2, however, may not include at least one of the communication apparatus 23, the input apparatus 24, and the output apparatus 25. The arithmetic apparatus 21, the storage apparatus 22, the communication apparatus 23, the input apparatus 24, and the output apparatus 25 may be connected through a data bus 26.

The arithmetic apparatus 21 includes at least one of a CPU (Central Processing Unit), a GPU (Graphics Processing Unit), and a FPGA (Field Programmable Gate Array), for example. The arithmetic apparatus 21 reads a computer program. For example, the arithmetic apparatus 21 may read a computer program stored in the storage apparatus 22. For example, the arithmetic apparatus 21 may read a computer program stored by a computer-readable and non-transitory recording medium, by using a not-illustrated recording medium reading apparatus provided in the information processing apparatus 2 (e.g., the input apparatus 24 described later). The arithmetic apparatus 21 may acquire (i.e., download or read) a computer program from a not-illustrated apparatus disposed outside the information processing apparatus 2, through the communication apparatus 23 (or another communication apparatus). The arithmetic apparatus 21 executes the read computer program. Consequently, a logical functional block for performing an operation to be performed by information processing apparatus 2 is realized or implemented in the arithmetic apparatus 21. That is, the arithmetic apparatus 21 is allowed to function as a controller for realizing or implementing the logical functional block for performing an operation (in other words, processing) to be performed by information processing apparatus 2.

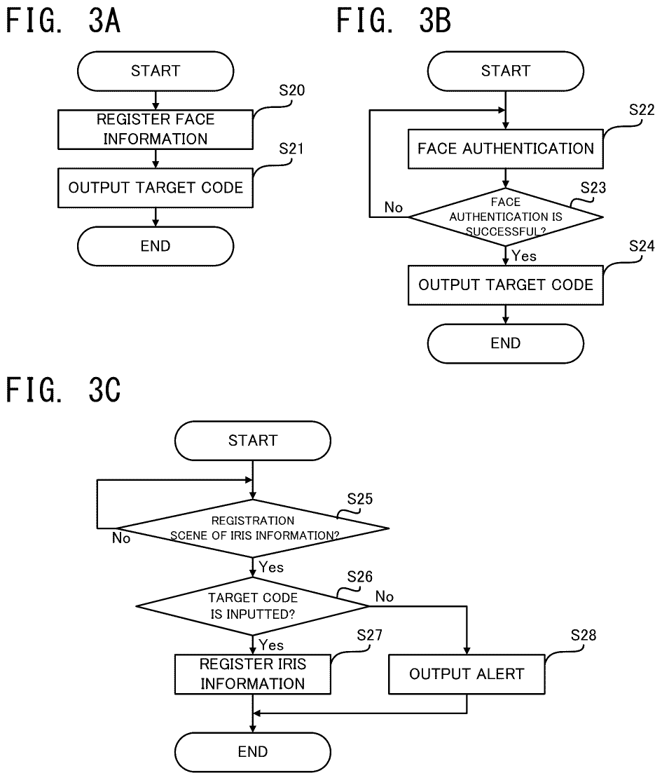

FIG. 2 illustrates an example of the logical functional block realized or implemented in the arithmetic apparatus 21 to perform an information processing operation. As illustrated in FIG. 2, a code output unit 211 that is a specific example of the “code output unit” described in Supplementary Note later, an iris information registration unit 212 that is a specific example of the “iris information registration unit” described in Supplementary Note later, an alert output unit 213 that is a specific example of the “alert output unit” described in Supplementary Note later, a face image acquisition unit 214, a face information registration unit 215, a face authentication unit 216, and an iris image acquisition unit 217 are realized or implemented in the arithmetic apparatus 21. The arithmetic apparatus 21, however, may not include at least one of the alert output unit 213, the face image acquisition unit 214, the face information registration unit 215, the face authentication unit 216, and the iris image acquisition unit 217. Detailed operation of each of the code output unit 211, the iris information registration unit 212, the alert output unit 213, the face image acquisition unit 214, the face information registration unit 215, the face authentication unit 216, and the iris image acquisition unit 217 will be described in detail later with reference to FIGS. 3A to 3C.

The storage apparatus 22 is configured to store desired data. For example, the storage apparatus 22 may temporarily store a computer program to be executed by the arithmetic apparatus 21. The storage apparatus 22 may temporarily store data that are temporarily used by the arithmetic apparatus 21 when the arithmetic apparatus 21 executes the computer program. The storage apparatus 22 may store data that are stored by the information processing apparatus 2 for a long time. The storage apparatus 22 may include at least one of a RAM (Random Access Memory), a ROM (Read Only Memory), a hard disk apparatus, a magneto-optical disk apparatus, a SSD (Solid State Drive), and a disk array apparatus. That is, the storage apparatus 22 may include a non-transitory recording medium. The storage apparatus 22 may store a biometric information DB 221. In the second example embodiment, the biometric information DB 221 may be a database that associates the identification information capable of identifying the target person, the face information on the target person, and the iris information on the target person. The storage apparatus 22, however, may not store the biometric information DB 221.

The communication apparatus 23 is configured to communicate with an apparatus external to the information processing apparatus 2 through a not-illustrated communication network. The information processing apparatus 2 may transmit and receive a signal to and from a portable terminal held by the target person through the communication apparatus 23.

The input apparatus 24 is an apparatus that receives an input of information to the information processing apparatus 2 from an outside of the information processing apparatus 2. For example, the input apparatus 24 may include an operating apparatus (e.g., at least one of a keyboard, a mouse, and a touch panel) that is operable by an operator of the information processing apparatus 2. For example, the input apparatus 24 may include a reading apparatus that is configured to read information recorded as data on a recording medium that is externally attachable to the information processing apparatus 2.

The output apparatus 25 is an apparatus that outputs information to the outside of the information processing apparatus 2. For example, the output apparatus 25 may output information as an image. That is, the output apparatus 25 may include a display apparatus (a so-called display) that is configured to display an image indicating the information that is desirably outputted. For example, the output apparatus 25 may output information as audio/sound. That is, the output apparatus 25 may include an audio apparatus (a so-called speaker) that is configured to output audio/sound. For example, the output apparatus 25 may output information onto a paper surface. That is, the output apparatus 25 may include a print apparatus (a so-called printer) t that is configured to print desired information on the paper surface.

### 2-2: Iris Information Registration Operation Performed by Information Processing Apparatus 2

Next, with reference to FIGS. 3A to 3C, an iris information registration operation performed by the information processing apparatus 2 according to the second example embodiment will be described. FIGS. 3A to 3C is a diagram illustrating a flow of the iris information registration operation performed by the information processing apparatus 2 according to the second example embodiment.

FIG. 3A is a diagram illustrating a flow of the iris information registration operation performed by the information processing apparatus 2 according to the second example embodiment when registering the face information. As illustrated in FIG. 3A, the face information registration unit 215 registers the face information on the target person (step S20). The face information is information used for the face authentication of the target person. The face information may be a face feature quantity extracted from a face image of the target person. The face image acquisition unit 214 may acquire the face image generated by imaging the face of the target person. The face image of the target person may be captured by a camera mounted on the portable terminal held by the target person, and the face image acquisition unit 214 may acquire the face image from the portable terminal held by the target person through the communication apparatus 23. In this case, at the timing of acquiring the face image, the information processing apparatus 2 may acquire a destination for transmitting information to the target person, such as a telephone number and an email address of the target person. The face information registration unit 215 may register the face information on the target person in the biometric information DB 221 in association with the identification information capable of identifying the target person. The face information on the target person registered in the biometric information DB 221 may be used for the face authentication of the target person.

The code output unit 211 issues the target person code to the target person (step S21). The target person code is a code issued in the registration of the face information, in order to prevent spoofing in the registration of the iris information after the registration of the face information. The target person code may be, for example, a code associated with the identification information capable of identifying the target person. The code output unit 211 may transmit the target person code to the portable terminal held by the target person through the communication apparatus 23.

FIG. 3B is a diagram illustrating a flow of the iris information registration operation performed by the information processing apparatus 2 according to the second example embodiment when performing the face authentication. As illustrated in FIG. 3B, the face authentication unit 216 performs the face authentication of the target person (step S22). The face image acquisition unit 214 may acquire the face image of the target person, and the face authentication unit 216 may extract the face information from the acquired face image and may collate/verify it with the face information registered in the biometric information DB 221. The face authentication unit 216 determines whether or not the face authentication is successful (step S23).

When the face authentication is successful (the step S23: Yes), the code output unit 211 issues the target person code to the target person (step S24). For example, the code output unit 211 may transmit the target person code to the destination for transmitting the information to the target person acquired at the time of registering the face image, through the communication apparatus 23. When the face authentication is failed (the step S23: No), the face authentication unit 216 may perform the face authentication again, for example.

FIG. 3C is a diagram illustrating a flow of the iris information registration operation performed by the information processing apparatus 2 in the second example embodiment when registering the iris information. The operation illustrated in FIG. 3C is performed after the operation illustrated in at least one of FIG. 3A and FIG. 3B.

As illustrated in FIG. 3C, the iris information registration unit 212 determines whether it is a registration scene of the iris information (step S25). The iris information is information used for iris authentication of the target person. The registration scene of the iris information may be a scene where the target person is about to register the iris information. The iris information registration unit 212 may determine that the target person is about to register the iris information when it detects that the target person is in front of an iris camera that images an iris image, for example. The iris information may be the iris image including an iris of the target person. The iris information may be an iris feature quantity extracted from the iris image of the target person.

When it is the registration scene of the iris information (the step S25: Yes), the iris information registration unit 212 determines whether or not the target person code is inputted by the target person (step S26). The target person code is the target code issued by the code output unit 211 in the step S21 in FIG. 3A and the step S24 in FIG. 3B. When the target person code is inputted by the target person (the step S26: Yes), the iris image acquisition unit 217 collects the iris information on the target person. The iris information registration unit 212 registers the iris information in association with the identification information capable of identifying the target person and the registered face information on the target person (step S27). The iris information on the target person registered in the biometric information DB 221 may be used for the iris authentication of the target person. The iris image acquisition unit 217 may acquire the iris image from an iris camera that images the iris of the target person, through the communication apparatus 23. The iris image acquisition unit 217 may extract the iris feature quantity as the iris information from the iris image.

When a code that is different from the target person code is inputted by the target person (the step S26: No), the alert output unit 213 outputs an alert to the target person (step S28). In addition, when the code that is different from the target person code is inputted by the target person, the iris information registration unit 212 does not register the iris information on the target person in association with the identification information capable of identifying the target person and the registered face information on the target person.

### 2-3: Technical Effect of Information Processing Apparatus 2

The information processing apparatus 2 according to the second example embodiment outputs an alert to the target person when the code that is different from the target person code issued at the time of registering the face information and the authentication is inputted. It is therefore possible to reliably associate the iris information on the target person with the information capable of identifying the target person. Even in the second example embodiment, the iris information is registered in association with the identification information and the face information, in the case where the target person code is inputted by the target person when the iris information used for the iris authentication of the target person is registered. It is therefore possible to reliably associate the iris information on the target person with the information capable This can prevent the iris information from being registered by of identifying the target person. the person who impersonates the target person.

### 3: Third Example Embodiment

Next, an information processing apparatus, an information processing method, and a recording medium according to a third example embodiment will be described. The following describes the information processing apparatus, the information processing method, and the recording medium according to the third example embodiment, by using an information processing apparatus 3 to which the information processing apparatus, the information processing method, and the recording medium according to the third example embodiment are applied.

### 3-1: Configuration of Information Processing Apparatus 3

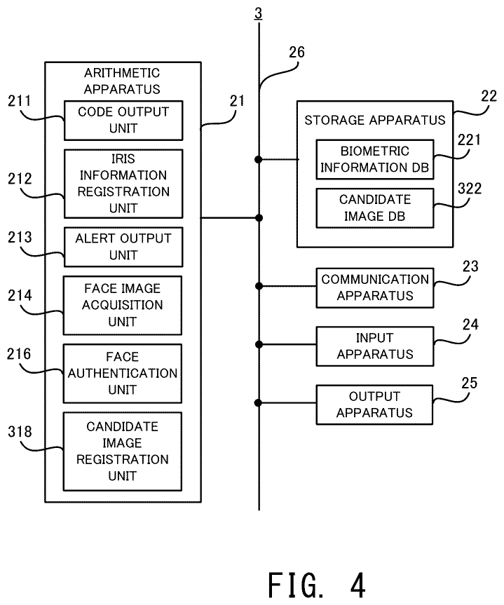

With reference to FIG. 4, a configuration of the information processing apparatus 3 according to the third example embodiment will be described. FIG. 4 is a block diagram illustrating the configuration of the information processing apparatus 3 according to the third example embodiment.

As illustrated in FIG. 4, the information processing apparatus 3 according to the third example embodiment includes the arithmetic apparatus 21 and the storage apparatus 22, as in the information processing apparatus 2 according to the second example embodiment. Furthermore, the information processing apparatus 3 may include the communication apparatus 23, the input apparatus 24, and the output apparatus 25, as in the information processing apparatus 2 according to the second example embodiment. The information processing apparatus 3, however, may not include at least one of the communication apparatus 23, the input apparatus 24, and the output apparatus 25. The information processing apparatus 3 according to the third example embodiment is different from the information processing apparatus 2 according to the second example embodiment, in that the arithmetic apparatus 21 further includes a candidate image registration unit 318 and the storage apparatus 22 further includes a candidate image DB 322. The candidate image DB 322 may be a database that associates the identification information capable of identifying the target person with the face image of the target person. The storage apparatus 22, however, may not store the candidate image DB 322. Other features of the information processing apparatus 3 may be the same as those of the information processing apparatus 2 according to the second example embodiment. For this reason, a part that is different from each of the example embodiments described above will be described in detail below, and a description of the other overlapping parts will be omitted as appropriate.

### 3-2: Iris Information Registration Operation Performed by Information Processing Apparatus 3

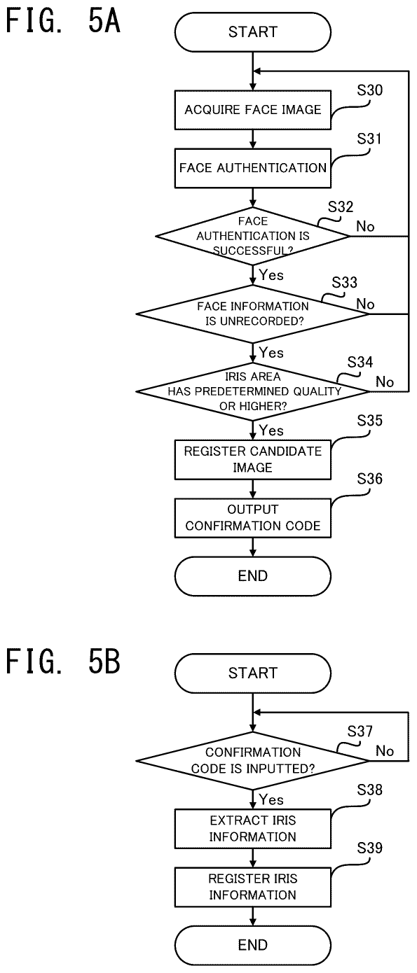

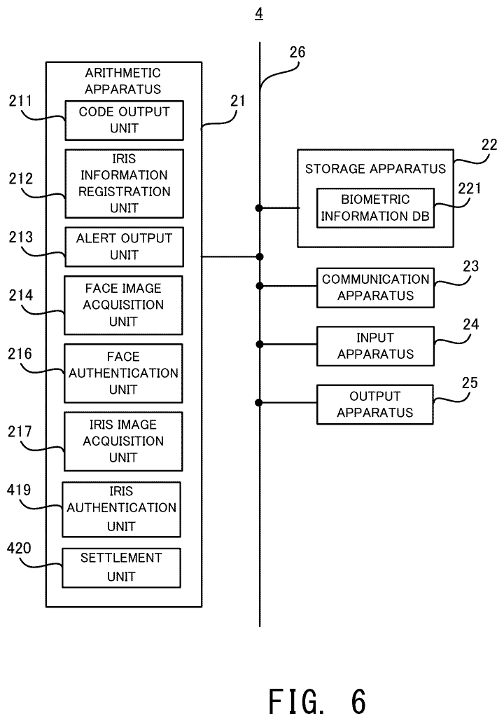

With reference to FIGS. 5A and 5B, an iris information registration operation performed by the information processing apparatus 3 according to the third example embodiment will be described. FIGS. 5A and 5B is a diagram illustrating a flow of the iris information registration operation performed by the information processing apparatus 3 according to the third example embodiment.

As illustrated in FIG. 5A, the face image acquisition unit 214 acquires the face image generated by imaging the face of the target person to be subjected to the face authentication (step S30). The face image of target person may be captured by a camera mounted on the portable terminal held by the target person, and the face image acquisition unit 214 may acquire the face image from the portable terminal held by the target person through the communication apparatus 23.

The face authentication unit 216 performs the face authentication by using the face image acquired in the step S30 (step S31). The candidate image registration unit 318 determines whether or not the face authentication in the step S31 is successful (step S32). When the face authentication is successful (the step S32: Yes), the candidate image registration unit 318 determines whether the iris information on the target person is unregistered in the biometric information DB 221 (step S33). When the iris information on the target person is unregistered (the step S33: Yes), the candidate image registration unit 318 determines whether or not an iris area of the face image acquired in the step S30 has quality that is higher than or equal to a predetermined quality (step S34).

When the iris area has quality that is higher than or equal to a predetermined quality (the step S34: Yes), the candidate image registration unit 318 registers the face image acquired in the step S30, as a candidate image for extracting the iris information (step S35). The candidate image registration unit 318 may register the face image acquired in the stepping S30, as the candidate image for extracting iris information in the candidate image DB 322, in association with the identification information capable of identifying the target person. That is, the candidate image registration unit 318 registers the face image as the candidate image for extracting the iris information (1) when the face authentication of the target person is successful (the step S32: Yes), (2) when the iris information on the target person is unregistered (the step S33: Yes), and (3) when the iris area of the face image has quality that is higher than or equal to a predetermined quality (the step S34: Yes). On the other hand, when any of the determination in the step S32, the step S33, and the step S34 is negated, the operation may be returned to the step S30, for example.

The candidate image registration unit 318 issues a confirmation code to the target person (step S36). The confirmation code may be, for example, a code associated with the identification information capable of identifying the target person. The candidate image registration unit 318 may transmit the target person code to the destination for transmitting the information to the target person acquired in the registration of the face image, through the communication apparatus 23, for example. After the step S36, the candidate image registration unit 318 may wait for the confirmation code to be inputted from the target person.

As illustrated in FIG. 5B, the candidate image registration unit 318 determines whether or not the confirmation code is inputted (step S37). The candidate image registration unit 318 may repeat the step until the confirmation code is inputted.

When the confirmation code is inputted (the step S37: Yes), the iris information registration unit 212 extracts the iris information from the candidate image (step S38). The iris information registration unit 212 may extract the iris information from the candidate image registered in the candidate image DB 322 at the timing when the confirmation code is inputted.

The iris information registration unit 212 registers the extracted iris information in association with identification information and the face information (step S39). The iris information registration unit 212 may register the extracted iris information in the biometric information DB 221, in association with the identification information and the face information.

### 3-3: Technical Effect of Information Processing Apparatus 3

The information processing apparatus 3 according to the third example embodiment is capable of easily registering the iris information without capturing the iris image for registering the iris information. In addition, the information processing apparatus 3 registers the iris information extracted from the face image when the confirmation code is inputted. It is therefore possible to easily register the iris information while ensuring that the iris information on the person in question is reliably registered.

### 4: Fourth Example Embodiment

An information processing apparatus, an information processing method, and a recording medium according to a fourth example embodiment will be described. The following describes the information processing apparatus, the information processing method, and the recording medium according to the fourth example embodiment, by using an information processing apparatus 4 to which the information processing apparatus, the information processing method, and the recording medium according to the fourth example embodiment are applied.

### 4-1: Configuration of Information Processing Apparatus 4

With reference to FIG. 6, a configuration of the information processing apparatus 4 according to the fourth example embodiment will be described. FIG. 6 is a block diagram illustrating the configuration of the information processing apparatus 4 according to the fourth example embodiment.

As illustrated in FIG. 6, the information processing apparatus 4 according to the fourth example embodiment includes the arithmetic apparatus 21 and the storage apparatus 22, as in the information processing apparatus 2 according to the second example embodiment and the information processing apparatus 3 according to the third example embodiment. Furthermore, the information processing apparatus 4 may include the communication apparatus 23, the input apparatus 24, and the output apparatus 25, as in the information processing apparatus 2 according to the second example embodiment and the information processing apparatus 3 according to the third example embodiment. The information processing apparatus 4, however, may not include at least one of the communication apparatus 23, the input apparatus 24, and the output apparatus 25. The information processing apparatus 4 according to the fourth example embodiment is different from the information processing apparatus 2 according to the second example embodiment and the information processing apparatus 3 according to the third example embodiment, in that the arithmetic apparatus 21 further includes an iris authentication unit 419 and a settlement unit 420. That is, the information processing apparatus 4 is an apparatus configured to perform multi-modal authentication of the face authentication and the iris authentication. Other features of the information processing apparatus 4 may be the same as those of the information processing apparatus 2 according to the second example embodiment or the information processing apparatus 3 according to the third example embodiment. For this reason, a part that is different from each of the example embodiments described above will be described in detail below, and a description of the other overlapping parts will be omitted as appropriate. Although it is not described, the information processing apparatus 4 according to the fourth example embodiment may register the iris information in the biometric information DB 221 by the same operation as that of at least one of the information processing apparatus 2 according to the second example embodiment and the information processing apparatus 3 according to the third example embodiment.

### 4-2: Information Processing Operation Performed by Information Processing Apparatus 4

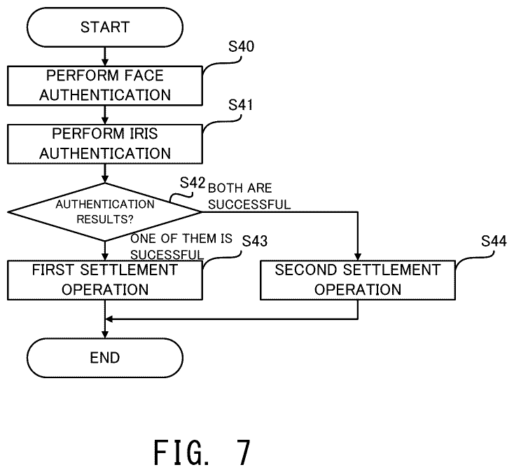

Next, with reference to FIG. 7, an information processing operation performed by the information processing apparatus 4 according to the fourth example embodiment will be described. FIG. 7 is a diagram illustrating a flow of the information processing operation performed by the information processing apparatus 4 according to the fourth example embodiment.

As illustrated in FIG. 7, the face authentication unit 216 performs the face authentication of the target person (step S40). The face image acquisition unit 214 may acquire the face image of the target person, and the face authentication unit 216 may extract the face information from the acquired face image and may collate/verify it with the face information registered in the biometric information DB 221.

The iris authentication unit 419 performs the iris authentication of the target person (step S41). The iris image acquisition unit 217 may acquire the iris image of the target person, and the iris authentication unit 419 may extract the iris information from the acquired iris image and may collate/verify it with the iris information registered in the biometric information DB 221. Alternatively, when the iris area of the face image used for the face authentication has quality that is higher than or equal to a predetermined quality, the iris authentication unit 419 may extract the iris information from the iris area of the face image and may collate/verify it with the iris information registered in the biometric information DB 221.

The settlement unit 420 determines whether or not the face authentication in the step S40 and the iris authentication in the step S41 are successful (step S42). The settlement unit 420 perform a settlement when at least one of the face authentication and the iris authentication is successful.

When one of the face authentication and the iris authentication is successful (the step S42: one of them is successful), the settlement unit 420 performs a first settlement operation (step S43). When both of the face authentication and the iris authentication are successful (the step S42: both are successful), the settlement unit 420 performs a second settlement operation (step S44). That is, the settlement unit 420 performs different operations regarding the settlement between (i) when one of the face authentication and the iris authentication is successful and (ii) when both of the face authentication and the iris authentication are successful.

The second settlement is a settlement performed when authentication accuracy is higher than that of the first settlement, and thus may be a settlement favorable to the target person. For example, the second settlement may have a wider range to perform the settlement, than that of the first settlement. For example, in the second settlement, more points may be given at the time of settlement, than those in the first settlement. In addition, for example, a settlement amount of the second settlement may be discounted, as compared with that of the first settlement.

### 4-3: Technical Effect of Information Processing Apparatus 4

The information processing apparatus 4 according to the fourth example performs different operations regarding the settlement in accordance with the authentication method. It is therefore possible to change the service that can be received by the target person. When the authentication is performed in multi modals, the authentication accuracy is high. It is therefore possible to provide more services to the target person authenticated by a method in which the authentication accuracy is high.

### 5: Fifth Example Embodiment

Next, an information processing apparatus, an information processing method, and a recording medium according to a fifth example embodiment will be described. The following describes the information processing apparatus, the information processing method, and the recording medium according to the fifth example embodiment, by using an information processing apparatus 5 to which the information processing apparatus, the information processing method, and the recording medium according to the fifth example embodiment are applied.

### 5-1: Configuration of Information Processing Apparatus 5

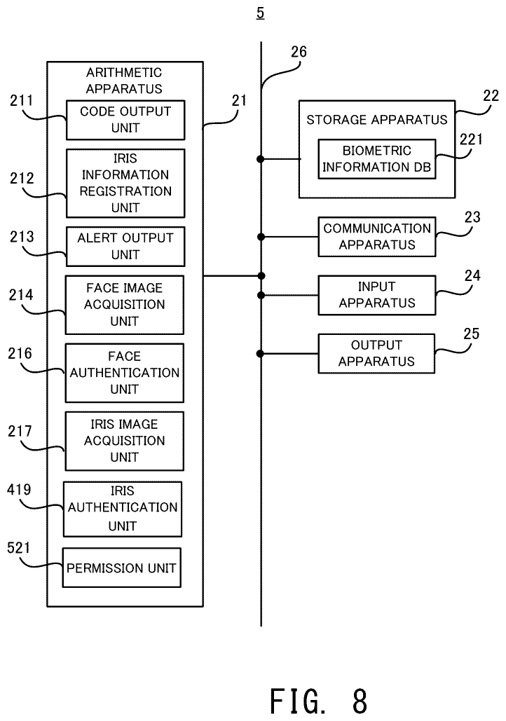

With reference to FIG. 8, a configuration of the information processing apparatus 5 according to the fifth example embodiment will be described. FIG. 8 is a block diagram illustrating the configuration of the information processing apparatus 5 according to the fifth example embodiment.

As illustrated in FIG. 8, the information processing apparatus 5 according to the fifth example embodiment includes the arithmetic apparatus 21 and the storage apparatus 22, as in the information processing apparatus 2 according to the second example embodiment to the information processing 4 according to the fourth example embodiment. Furthermore, the information processing apparatus 5 may include the communication apparatus 23, the input apparatus 24, and the output apparatus 25, as in the information processing apparatus 2 according to the second example embodiment to the information processing apparatus 4 according to the fourth example embodiment. The information processing apparatus 5, however, may not include at least one of the communication apparatus 23, the input apparatus 24, and the output apparatus 25. The information processing apparatus 5 according to the fifth example embodiment is different from the information processing apparatus 2 according to the second example embodiment to the information processing apparatus 4 according to the fourth example embodiment, in that the arithmetic apparatus 21 further includes a permission unit 521. Other features of the information processing apparatus 5 may be the same as those of at least of the information processing apparatus 2 according to the second example embodiment to the information processing apparatus 4 according to the fourth example embodiment. For this reason, a part that is different from each of the example embodiments described above will be described in detail below, and a description of the other overlapping parts will be omitted as appropriate. Although it is not described, the information processing apparatus 5 according to the fifth example embodiment may register the iris information in the biometric information DB 221 by the same operation as that of at least one of the information processing apparatus 2 according to the second example embodiment and the information processing apparatus 3 according to the third example embodiment.

### 5-2: Entry Permission Operation Performed by Information Processing Apparatus 5

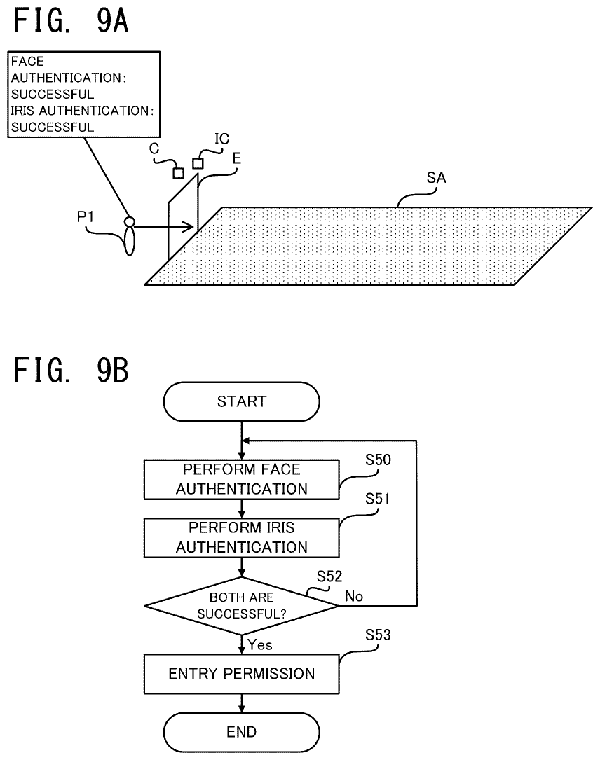

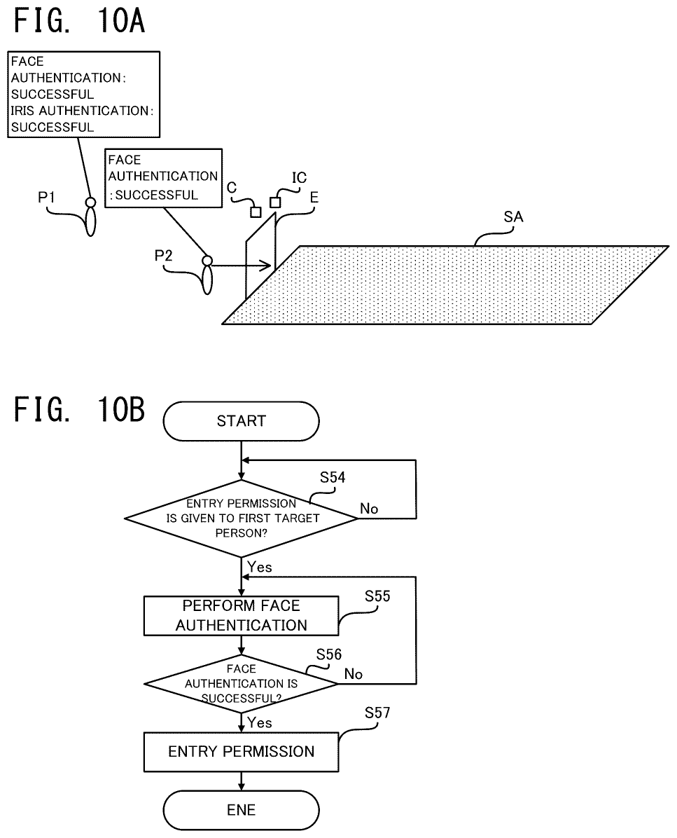

Next, an entry permission operation performed by the information processing apparatus 5 according to the fifth example embodiment will be described with reference to FIGS. 9A and 9B to FIGS. 12A and 12B.

FIGS. 9A and 9B is a diagram for explaining permission of an entry of a first target person P1, which is performed by the information processing apparatus 5 according to the fifth example embodiment. The first target person Pl has a first role. The first role may be, for example, a secretary of a company officer. FIG. 9A is a conceptual diagram illustrating an example of a first scene where the information processing apparatus 5 according to the fifth example embodiment is applied. As illustrated in FIG. 9A, the information processing apparatus 5 may give entry permission to the first target person P1 who wants to enter a specific area SA, at an entrance E of the specific area SA. In the vicinity of the entrance E, a camera C and an iris camera IC are disposed, and the information processing apparatus 5 may be capable of performing both of the face authentication and the iris authentication.

FIG. 9B is a diagram illustrating a flow of the entry permission operation of permitting the entry of the first target person P1, which is performed by the information processing apparatus 5 according to the fifth example embodiment. As illustrated in FIG. 9B, the face authentication unit 216 performs the face authentication of the first target person P1 (step S50). The face image acquisition unit 214 may acquire the face image of the first target person P1 captured by the camera C provided near the entrance E. The face authentication unit 216 may extract the face information from the acquired face image and may collate/verify it with the face information registered in the biometric information DB 221.

The iris authentication unit 419 performs the iris authentication of the first target person P1 (step S51). The iris image acquisition unit 217 may acquire the iris image of the first target person P1 captured by the iris camera IC provided near the entrance E. The iris authentication unit 419 may extract the iris information from the acquired iris image and may collate/verify it with the iris information registered in the biometric information DB 221. Alternatively, when the iris area of the face image used for the face authentication has quality that is higher than or equal to a predetermined quality, the iris authentication unit 419 may extract the iris information from the iris area of the face image and may collate/verify it with the iris information registered in the biometric information DB 221.

The permission unit 521 determines whether or not both of the face authentication in the step S50 and the iris authentication in the step S51 are successful (step S52). When both of the face authentication in the step S50 and the iris authentication in the step S51 are successful (the step S52: Yes), the permission unit 521 permits the first target person P1 to enter the specified area SA, as illustrated in FIG. 9A (step S53). When at least one of the face authentication in the step S50 and the iris authentication in the step S51 is failed (the step S52: No) the operation may be returned to the step S50, for example.

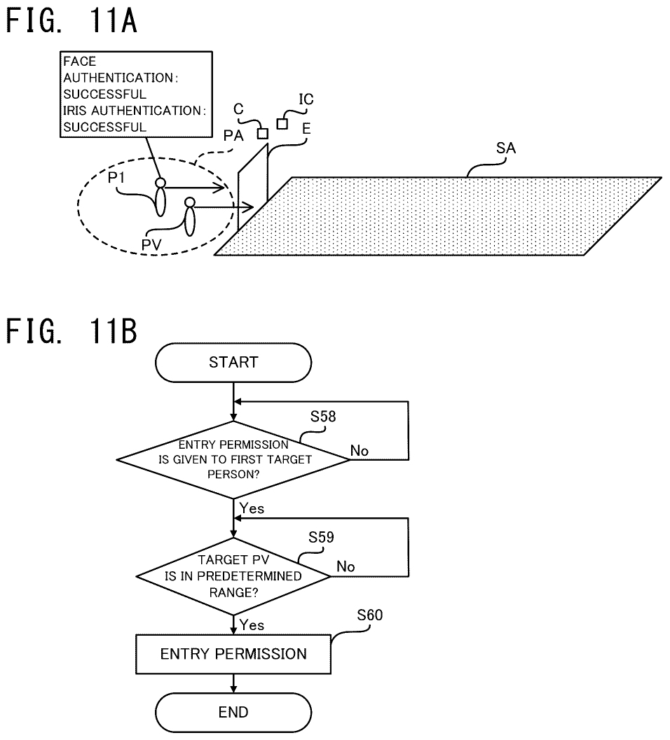

FIGS. 10A and 10B is a diagram for explaining permission of an entry of the second target person P2, which is performed by the information processing apparatus 5 according to the fifth example embodiment. The second target person P2 is associated with the first target person P1 and has a second role. The first target person P1 having the first role and the second target person P2 having the second role may be persons who belong to the same organization. The first target person P1 having the first role may be in a position to undertake a laborious operation, as compared with the second target person P2 having the second role. The second role may be, for example, a company officer. The second target person P2 may be a company officer associated with the first target person P1 who is the secretary. FIG. 10A is a conceptual diagram illustrating an example of a second scene where the information processing apparatus 5 according to the fifth example embodiment is applied. As illustrated in FIG. 10A, the information processing apparatus 5 may give entry permission to the second target person P2 who wants to enter the specific area SA, at the entrance E of the specific area SA. As in the first scene, the camera C and the iris camera IC may be disposed in the vicinity of the entrance E, and the information processing apparatus 5 may be capable of performing both of the face authentication and the iris authentication.

FIG. 10B is a diagram illustrating a flow of the entry permission operation of permitting the entry of the second target person P2, which is performed by the information processing apparatus 5 according to the fifth example embodiment. As illustrated in FIG. 10B, the permission unit 521 determines whether or not the entry permission is given to the first target person P1 (step S54). That is, the permission unit 521 determines whether or not the first target person P1 has succeeded in both of the face authentication and the iris authentication. When the entry permission is not given to the first target person P1 (the step S54: No), the operation may be returned to the step S54, for example.

When the entry permission is given to the first target person P1 (the step S54: Yes), the face authentication unit 216 performs the face authentication of the second target person P2 (step S55). The face image acquisition unit 214 may acquire the face image of the second target person P2 captured by the camera C provided near the entrance E. The face authentication unit 216 may extract the face information from the acquired face image and may collate/verify it with the face information registered in the biometric information DB 221.

The permission unit 521 determines whether or not the face authentication of the second target person P2 is successful (step S56). When the face authentication of the second target person P2 is successful (the step S56, Yes), the permission unit 521 permits the second target person P2 to enter the specific area SA, as illustrated in FIG. 10B (step S57). When the face authentication in the step S55 is failed (the step S56: No), the operation may be returned to the step S55, for example.

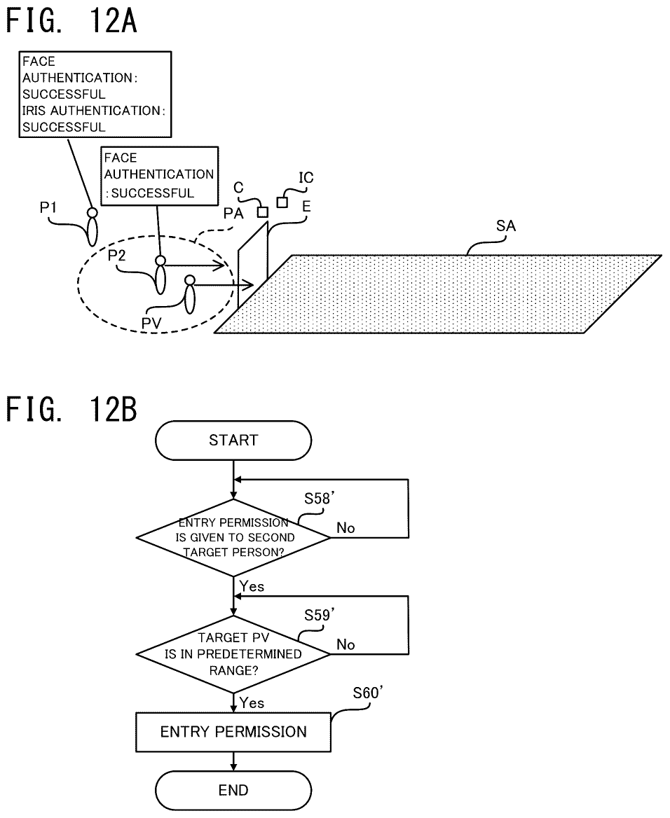

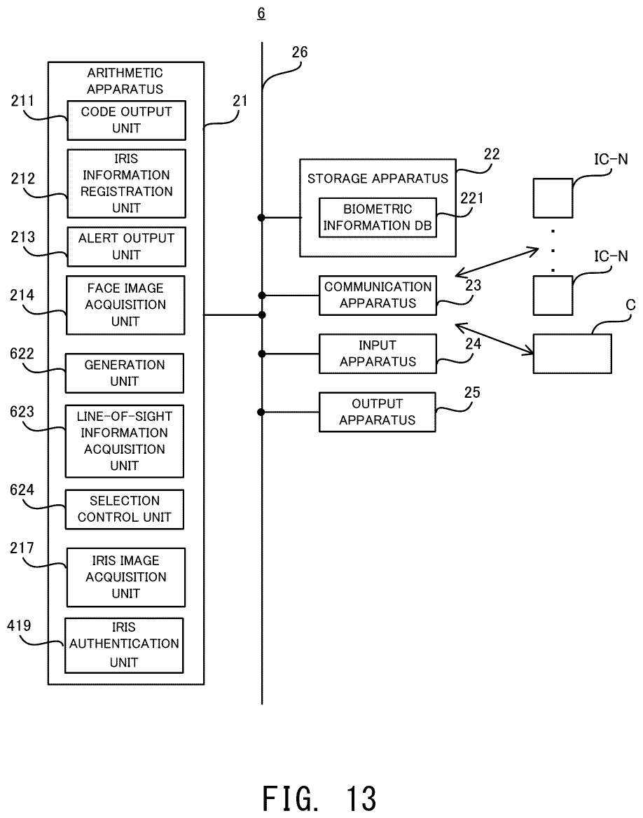

FIGS. 11A and 11B is a diagram explaining a first example of permission of an entry of a special treatment target person PV, which is performed by the information processing apparatus 5 according to the fifth example embodiment. The special treatment target person PV has a third role. The special treatment target person PV having the third role may be a person who does not belong to the organization to which the first target person P1 and the second target person P2 belong. The third role may be a customer who may receive special treatment. FIG. 11A is a conceptual diagram illustrating an example of a third scene where the information processing apparatus 5 according to the fifth example embodiment is applied. As illustrated in FIG. 11A, the information processing apparatus 5 may give entry permission to the special treatment target person PV who wants to enter the specific area SA, at the entrance E of the specific area SA. As in the first scene and the second scene, the camera C and the iris camera IC may be disposed in the vicinity of the entrance E, and the information processing apparatus 5 may be capable of performing both of the face authentication and the iris authentication.

FIG. 11B is a diagram illustrating a first flow of the entry permission operation of permitting the entry of the special treatment target person PV, which is performed by the information processing apparatus 5 according to the fifth example embodiment. As illustrated in FIG. 11B, the permission unit 521 determines whether or not the entry permission is given to the first target person P1 (step S58). That is, the permission unit 521 determines whether or not the first target person P1 has succeeded in both of the face authentication and the iris authentication. When the entry permission is not given to the first target person P1 (the step S58: No), the operation may be returned to the step S58, for example.

When the entry permission is given to the first target person P1 (the step S58: Yes), the permission unit 521 determines whether or not the special treatment target person PV is in a predetermined range PA including the first target person P1 (step S59). When the special treatment target person PV is not in the predetermined range PA including the first target person P1 (the step S59: No), the operation may be returned to the step S59, for example.

When the special treatment target person PV is in the predetermined range PA including the first target person P1 (the step S59: Yes), the permission unit 521 permits the special treatment target person PV to enter the specific area SA, as illustrated in FIG. 11A (step S60). The permission unit 521 may determine that a person in the predetermined range PA including the first target person P1 is a person who may enter the specified area SA with the first target person P1. The special treatment target person PV may enter the specific area SA with target person P1. In a case where a plurality of special treatment target persons PV are in the predetermined range PA including the first target person P1, the permission unit 521 may permit the plurality of special treatment target persons PV to enter the specific area SA. The number of persons that may enter the specific area SA with the first target person P1 may be set in advance.

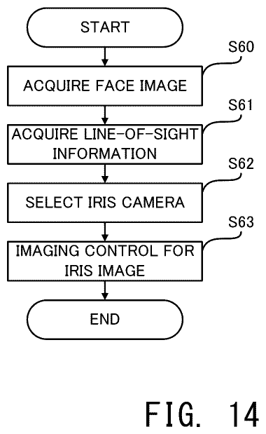

FIGS. 12A and 12B is a diagram illustrating a second example of permission of the entry of the special treatment target person PV, which is performed by the information processing apparatus 5 according to the fifth example embodiment. FIG. 12A is a conceptual diagram illustrating an example of a fourth scene where the information processing apparatus 5 according to the fifth example embodiment is applied.

FIG. 12B is a diagram illustrating a second flow of the entry permission operation of permitting the entry of the special treatment target person PV, which is performed by the information processing apparatus 5 according to the fifth example embodiment. As illustrated in FIG. 12B, the permission unit 521 determines whether or not the entry permission is given to the second target person P2 (step S58′). That is, the permission unit 521 determines whether the first target person P1 has succeeded in both of the face authentication and the iris authentication and the second target person P2 has succeeded in the face authentication. When the entry permission is not given to the second target person P2 (the step S58′: No), the operation may be returned to the step S58′, for example.

When the entry permission is given to the second target person P2 (the step S58′: Yes), the permission unit 521 determines whether or not the special treatment target person PV is in the predetermined range PA including the second target person P2 (step S59′). When the special treatment target person PV is not in the predetermined range PA including the second target person P2 (the step S59′: No), the operation may be returned to the step S59′, for example.

When the special treatment target person PV is in the predetermined range PA including the second target person P2 (the step S59′: Yes), the permission unit 521 permits the special treatment target person PV to enter the specific area SA, as illustrated in FIG. 12A (step S60′). The special treatment target person PV may enter the specific area SA with the second target person P2.

### 5-3: Technical Effect of Information Processing Apparatus 5

The information processing apparatus 5 according to the fifth example embodiment associates the second target person P2 with the first target person P1. It is therefore possible to reduce a burden imposed on the second target person P2, as compared with that of the first target person P1, when permitting the second target person P2 to enter the specific area SA. In addition, the information processing apparatus 5 permits the special treatment target person PV to enter the specific area SA when the special treatment target person PV is in the predetermined range PA including at least one of the first target person P1 and the second target person P2. It is therefore possible to reduce the burden imposed on the special treatment target person PV. The information processing apparatus 5 is capable of satisfying both of hospitality for the special treatment target person PV and security improvement.

### 6: Sixth Example Embodiment

Next, an information processing apparatus, an information processing method, and a recording medium according to a sixth example embodiment will be described. The following describes the information processing apparatus, the information processing method, and the recording medium according to the sixth example embodiment, by using an information processing apparatus 6 to which the information processing apparatus, the information processing method, and the recording medium according to the sixth example embodiment are applied.

### 6-1: Configuration of Information Processing Apparatus 6

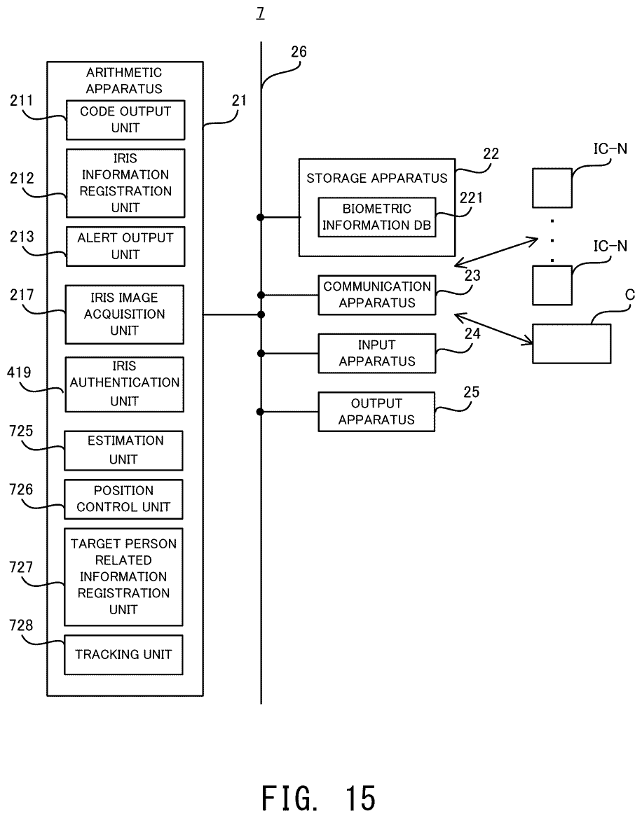

With reference to FIG. 13, a configuration of the information processing apparatus 6 according to the sixth example embodiment will be described. FIG. 13 is a block diagram illustrating the configuration of the information processing apparatus 6 according to the sixth example embodiment.

As illustrated in FIG. 13, the information processing apparatus 6 according to the sixth example embodiment includes the arithmetic apparatus 21 and the storage apparatus 22, as in the information processing apparatus 2 according to the second example embodiment to the information processing apparatus 5 according to the fifth example embodiment. Furthermore, the information processing apparatus 6 may include the communication apparatus 23, the input apparatus 24, and the output apparatus 25, as in the information processing apparatus 2 according to the second example embodiment to the information processing apparatus 5 according to the fifth example embodiment. The information processing apparatus 6, however, may not include at least one of the communication apparatus 23, the input apparatus 24, and the output apparatus 25. The information processing apparatus 6 according to the sixth example embodiment is different from the information processing apparatus 2 according to the second example embodiment to the information processing apparatus 5 according to the fifth example embodiment, in that the arithmetic apparatus 21 further includes a generation unit 622, a line-of-sight information acquisition unit 623, and a selection control unit 624. The information processing apparatus 6 according to the sixth example embodiment transmits information to and receives it from the camera C and a plurality of iris cameras IC through the communication apparatus 23.

The camera C may be disposed to be capable of imaging a predetermined space in order to image the target person, and may image the predetermined space. The camera C may be disposed at a position where an eye of an average person is easily captured. The camera C may be disposed at a height of 2.5 meters, for example. The camera C may be provided to be capable of imaging the target person in an overhead view.

Each of the plurality of iris cameras IC captures the iris of the target person and generates the iris image. The plurality of iris cameras IC may be disposed at different locations such that different parts can be imaged.

Other features of the information processing apparatus 6 may be the same as those of at least one of the information processing apparatus 2 according to the second example embodiment to the information processing apparatus 5 according to the fifth example embodiment. For this reason, a part that is different from each of the example embodiments described above will be described in detail below, and a description of the other overlapping parts will be omitted as appropriate. Although it is not described, the information processing apparatus 6 according to the sixth example embodiment may register the iris information in the biometric information DB 221 by the same operation as that of at least one of the information processing apparatus 2 according to the second example embodiment and the information processing apparatus 3 according to the third example embodiment.

### 6-2: Authentication Related Operation Performed by Information Processing Apparatus 6

Next, with reference to FIG. 14, an authentication related operation performed by the information processing apparatus 6 in the sixth example embodiment will be described. FIG. 14 is a diagram illustrating a flow of the authentication related operation performed by the information processing apparatus 6 according to the sixth example embodiment.

As illustrated in FIG. 14, the face image acquisition unit 214 acquires the face image of the target person to be subjected to the iris authentication (step S60). The face image acquisition unit 214 may acquire the face image of the target person from the camera C through the communication apparatus 23.

The generation unit 622 generates line-of-sight information on a line of sight of the target person, on the basis of the face image acquired in the step S60. The line-of-sight information may be information that identifies a position of a characteristic part around the eye such as an inner corner of the eye, an outer corner of the eye, and a pupil, which are necessary to detect the line of sight. The generation unit 622 may calculate a direction of the line of sight of the target person with respect to an optical axis direction of the camera C by identifying the position of the characteristic part around the eye, and may include it in the line-of-sight information. Furthermore, the generation unit 622 may calculate a distance between the target person and the camera C by identifying a distance between the eyes of the target person in the face image, and may include it in the line-of-sight information.

Alternatively, the camera C may be equipped with the function of the generation unit 622, and the face image of the target person acquired by the face image acquisition unit 214 may include the line-of-sight information generated by the generation unit 622. The line-of-sight information acquisition unit 623 acquires the line-of-sight information (step S61).

The selection control unit 624 selects any of the plurality of iris cameras IC on the basis of the line-of-sight information (step S62). The selection control unit 624 may select the iris camera IC suitable for imaging the iris of the target person, from the plurality of iris cameras IC on the basis of information indicating the direction of the line of sight of the target person included in the line-of-sight information.

The selection control unit 624 controls the selected iris camera IC to image the iris of the target person (step S63). The selection control unit 624 may control the selected iris camera IC to image the iris of the target person, through the communication apparatus 23, when the target person and the selected iris camera IC have an appropriate positional relation, on the basis of information indicating the distance between the target person and the camera C included in the line-of-sight information.

The iris image acquisition unit 217 may acquire the iris image of the iris of the target person from the selected iris camera, and the iris authentication unit 419 may perform the iris authentication of the target person by using the acquired iris image.

The information processing apparatus 6 may detect the line of sight of each of a plurality of target persons simultaneously, and may control the imaging of the iris image of each of the plurality of the target person simultaneously.

### 6-3: Technical Effect of Information Processing Apparatus 6

The information processing apparatus 6 according to the sixth example embodiment acquires the line-of-sight information on the target person, selects the iris camera IC that images the iris of the target person from the plurality of iris cameras IC on the basis of the line-of-sight information, and allows the selected iris camera IC to perform the imaging. It is therefore possible to reduce a processing load of the iris camera IC. The information processing apparatus 6 is capable of acquiring the iris image in which the line of sight of the target person is appropriate, without providing a mechanism for directing the line of sight such as an eye catch, near the iris camera IC, and without causing the target person to be aware that the iris image is being acquired.

### 7: Seventh Example Embodiment

Next, an information processing apparatus, an information processing method, and a recording medium according to a seventh example embodiment will be described. The following describes the information processing apparatus, the information processing method, and the recording medium according to the seventh example embodiment, by using an information processing apparatus 7 to which the information processing apparatus, the information processing method, and the recording medium according to the seventh example embodiment are applied.

### 7-1: Configuration of Information Processing Apparatus 7

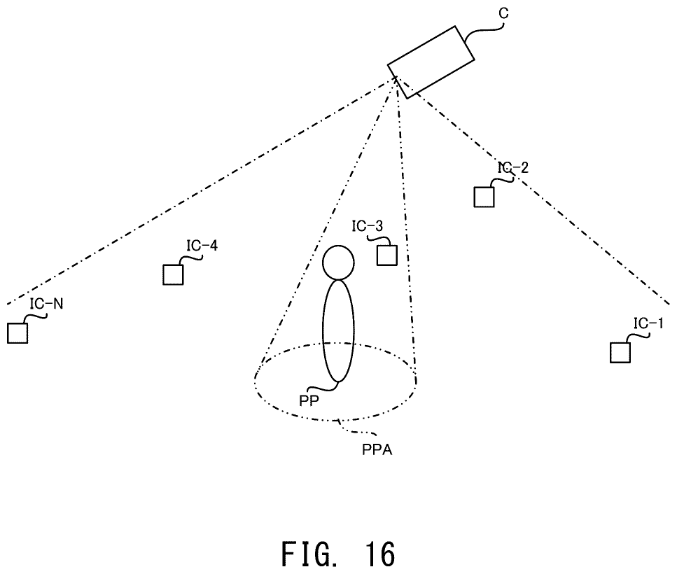

With reference to FIG. 15, a configuration of the information processing apparatus 7 according to the seventh example embodiment will be described. FIG. 15 is a block diagram illustrating the configuration of the information processing apparatus 7 according to the seventh example embodiment.

As illustrated in FIG. 15, the information processing apparatus 7 according to the seventh example embodiment includes the arithmetic apparatus 21 and the storage apparatus 22, as in the information processing apparatus 2 according to the second example embodiment to the information processing apparatus 6 according to the sixth example embodiment. Furthermore, the information processing apparatus 7 may include the communication apparatus 23, the input apparatus 24, and the output apparatus 25, as in the information processing apparatus 2 according to the second example embodiment to the information processing apparatus 6 according to the sixth example embodiment. The information processing apparatus 7, however, may not include at least one of the communication apparatus 23, the input apparatus 24, and the output apparatus 25. The information processing apparatus 7 according to the seventh example embodiment is different from the information processing apparatus 2 according to the second example embodiment to the information processing apparatus 6 according to the sixth example embodiment, in that the arithmetic apparatus 21 further includes an estimation unit 725, a position control unit 726, a target person related information registration unit 727, and a tracking unit 728. As in the information processing apparatus 6 according to the sixth example embodiment, the information processing apparatus 7 according to the seventh example embodiment transmits information to and receives it from the camera C and the plurality of iris cameras IC through the communication apparatus 23. Other features of the information processing apparatus 7 may be the same as those of at least one of the information processing apparatus 2 according to the second example embodiment to the information processing apparatus 6 according to the sixth example embodiment. For this reason, a part that is different from each of the example embodiments described above will be described in detail below, and a description of the other overlapping parts will be omitted as appropriate. Although it is not described, the information processing apparatus 7 according to the seventh example embodiment may register the iris information in the biometric information DB 221 by the same operation as that of at least one of the information processing apparatus 2 according to the second example embodiment and the information processing apparatus 3 according to the third example embodiment.

### 7-2: Application Example of Information Processing Apparatus 7

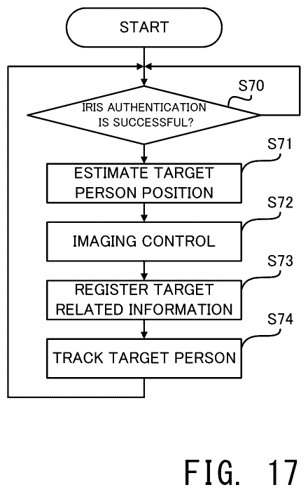

Next, with reference to FIG. 16, a description will be given to an example of a scene where the information processing apparatus 7 according to the seventh example embodiment is applied. FIG. 16 is a conceptual diagram illustrating an example of the scene where the information processing apparatus 7 according to the seventh example embodiment is applied. The information processing apparatus 7 according to the seventh example embodiment may be used for tracking a person in marketing, entry and exit control, or the like.

The camera C may be disposed to be capable of imaging a predetermined space in order to image the target person, and may image the predetermined space. The camera C may be disposed at a height of 2.5 meters, for example. When the camera C is disposed at a higher position than a height of an average person, the image captured by the camera C tends to include not only a face area of the target person and an upper-body area of the target person, but also a full-body area of the target person. The camera C may be provided to be capable of performing the imaging in a condition of capturing an entire scene where the seventh example embodiment is applied, in an overhead view.

Each of the plurality of iris cameras IC may be disposed in a position where the target person easily looks at. For example, if the scene where the seventh example embodiment is applied is a store, the iris camera IC may be disposed on a product display shelf.

### 7-3: Authentication Related Operation Performed by Information Processing Apparatus 7

Next, with reference to FIG. 17, an authentication related operation performed by the information processing apparatus 7 according to the seventh example embodiment will be described. FIG. 17 is a diagram illustrating a flow of the authentication related operation performed by the information processing apparatus 7 according to the seventh example embodiment.

### 7-3-1: First Operation

As illustrated in FIG. 17, the estimation unit 725 determines whether or not the iris authentication of the target person is successful (step S70). When the iris authentication is failed (the step S70: No), the operation may be returned to the step S70, for example. For example, if the scene where the seventh example embodiment is applied is a store, the first iris authentication may be performed at an entrance of the store.

When the iris authentication is successful (the step S70: Yes), the estimation unit 725 estimates a target person position PP of the target person identified by the iris authentication, on the basis of the iris information used for the iris authentication (step S71). In the seventh example embodiment, the iris information may include information indicating a distance between the target person and the iris camera IC, which is calculated by identifying the distance between the eyes of the target person in the iris image. In the seventh example embodiment, the iris information may include a direction of the line of sight of the target person with respect to an optical axis direction of the iris camera IC, which is calculated by identifying the characteristic part around the eye. In this case, the estimation unit 725 may estimate the target person position PP of the target person, on the basis of the information indicating the distance between the target person and the iris camera IC, and the direction of the line of sight of the target person.

The position control unit 726 controls the imaging to generate an image of an area PPA including the target person position (step S72). The position control unit 726 may control the camera C through the communication apparatus 23 to generate the image of the area PPA including the target person position.

The target person related information registration unit 727 detects a target person related area including at least one of the face area, a clothing area, and a wearing item area of the target person at the target person position in the image, and registers the target person related information about the target person related area, in association with the registered iris information on the corresponding target person (step S73). The target person related information registration unit 727 may register the target person related information in the biometric information DB 221 in association with the registered iris information on the corresponding target person.

In the seventh example embodiment, the biometric information DB 221 may be a database in which not only the identification information capable of identifying the target person, the face information on the target person, and the iris information on the target person, but also the target person related information is associated. The target person related information may be information for determining that the target person is the same person. The target person related area may be an area including information that allows determination of the target person who is in the scene where at least the seventh example embodiment is applied. For example, clothing such as clothes, and a wearing item such as eyeglasses and a watch, can be useful information to identify a person who is in a certain space-time.

The tracking unit 728 tracks the target person who has succeeded in the iris authentication (step S74). When the control is not performed by the position control unit 726, the camera C may image the entire scene where the seventh example embodiment is applied, in an overhead view. The tracking unit 728 may identify the target person from people included in the image, by using the target person related information registered in the biometric information DB 221. The camera C may capture a video. The tracking unit 728 may sequentially acquire a plurality of image frames that constitute the video captured by the camera C, as the image. The tracking unit 728 may track the target person on the basis of the target person related area of the target person detected from the image.

### 7-3-2: Second and Subsequent Operations

The estimation unit 725 may determine whether or not the iris authentication of the target person is successful during a tracking operation by the tracking unit 728. For example, when the iris authentication using the iris information extracted from the iris image captured by the iris camera IC disposed at a different position from the entrance of the store is successful (step S70: Yes), the estimation unit 725 estimates the target person position PP of the target person (step S71). The second and subsequent operations of the estimation unit 725 may be operations of reidentifying the target person position PP. Even when the position of the target person tracked by the tracking unit 728 is different from the target person position PP estimated by the estimation unit 725, i.e., even when the tracking by the tracking unit 728 is failed, it is possible to continue to track the target person by the operation(s) of reidentifying the target person position PP, which is performed by the estimation unit 725

The position control unit 726 controls the imaging to generate the image of the area PPA including the target person position (step S72). The target person related information registration unit 727 detects the target person related area in the image and registers the target person related information about the target person related area, in association with the registered iris information on the target person (step S73). Since the target person related information collected at different locations is registered in association with the identification information capable of identifying the target person, the target person related information collected at different locations may be managed as information about the same target person. For each success in the iris authentication, it is possible to increase the number of pieces of the target person related information that allows the determination that the target person is the same person.

### 7-3: Technical Effect of Information Processing Apparatus 7

The information processing apparatus 7 according to the seventh example embodiment is capable of accurately tracking behavior of the target person in a predetermined area on the basis of the target person related information that allows the determination that the target person is the same person in each success in the iris authentication. Even in a failure in the tracking of the target person based on the target person related area, it is possible to continue to track the target person by performing the iris authentication again.

### 8: Supplementary Notes

With respect to the example embodiment described above, the following Supplementary Notes are further disclosed.

### Supplementary Note 1

An information processing apparatus including:
a code output unit that outputs a target person code to a target person in at least one of a case where face information on the target person is registered and a case where face authentication of the target person is successful; and
an iris information registration unit that registers iris information collected from the target person, in association with identification information capable of identifying the target person and the registered face information on the target person, in a case where the target person code is inputted by the target person when registering the iris information on the target person.

### Supplementary Note 2

The information processing apparatus according to Supplementary Note 1, further including an alert output unit that outputs an alert to the target person in a case where a code that is different from the target person code is inputted by the target person when the iris information is registered, wherein
the iris information registration unit does not register the iris information on the target person in association with the identification information capable of identifying the target person and the registered face information on the target person, in the case where the code that is different from the target person code is inputted by the target person.

### Supplementary Note 3

The information processing apparatus according to Supplementary Note 1, further including:
a face image acquisition unit that acquires a face image of the target person generated by imaging a face of the target person to be subjected to the face authentication; and
a candidate image registration unit that registers the face image as a candidate image for extracting the iris information (1) when the face authentication of the target person is successful, (2) when the iris information on the target person is not registered, and (3) when an iris area of the face image has quality that is higher than or equal to a predetermined quality.

### Supplementary Note 4

The information processing apparatus according to Supplementary Note 3, wherein
the candidate image registration unit outputs a confirmation code to the target person when registering the candidate image, and
the iris information registration unit extracts the iris information from the candidate image and registers the iris information in association with the identification information and the face information in a case where the confirmation code is inputted by the target person.

### Supplementary Note 5

The information processing apparatus according to Supplementary Note 1, further including a settlement unit that performs a settlement when at least one of the face authentication and iris authentication is successful, and that performs different operations regarding the settlement between (i) when one of the face authentication and the iris authentication is successful and (ii) when both of the face authentication and the iris authentication are successful.

### Supplementary Note 6

The information processing apparatus according to Supplementary Note 1, further including a permission unit
that permits a first target person having a first role to enter a specific area when both of the face authentication and iris authentication are successful, and
that permits a second target person having a second role, who is associated with the first target person, to enter the specific area (a) when the first target person succeeds in both of the face authentication and the iris authentication and (2) when the second target person succeeds in the face authentication.

### Supplementary Note 7

The information processing apparatus according to Supplementary Note 6, wherein
when permitting at least one of the first target person and the second target person to enter the specific area,
the permission unit permits a third target person having a third role, who is in a predetermined range including at least one of the first target person and the second target person, to enter the specific area.

### Supplementary Note 8

The information processing apparatus according to Supplementary Note 1, further including:
a line-of-sight information acquisition unit that acquires line-of-sight information on the target person to be subjected to iris authentication; and
a selection control unit that selects any of a plurality of iris imaging units on the basis of the line-of-sight information and controls the selected iris imaging unit to image an iris of the target person.

### Supplementary Note 9

The information processing apparatus according to Supplementary Note 1, further including:
an estimation unit that estimates a target person position of the target person identified by iris authentication, on the basis of the iris information used for the iris authentication;
a position control unit that controls imaging to generate an image of an area including the target person position; and
a target person related information registration unit that detects a target person related area including at least one of a face area, a clothing area, and a wearing item area of the target person at the target person position in the image, and registers target person related information about the target person related area, in association with the registered iris information on the target person.

### Supplementary Note 10

An information processing method including:
outputting a target person code to a target person in at least one of a case where face information on the target person is registered and a case where face authentication of the target person is successful; and
registering iris information collected from the target person, in association with identification information capable of identifying the target person and the registered face information on the target person, in a case where the target person code is inputted by the target person when registering the iris information on the target person.

### Supplementary Note 11

A recording medium on which a computer program that allows a computer to execute an information processing method is recorded, the information processing method including:
outputting a target person code to a target person in at least one of a case where face information on the target person is registered and a case where face authentication of the target person is successful; and
registering iris information collected from the target person, in association with identification information capable of identifying the target person and the registered face information on the target person, in a case where the target person code is inputted by the target person when registering the iris information on the target person.

At least a part of the constituent components of each of the example embodiments described above can be combined with at least another part of the constituent components of each of the example embodiments described above, as appropriate. A part of the constituent components of each of the example embodiments described above may not be used.

This disclosure is not limited to the examples described above. This disclosure is allowed to be changed, if desired, without departing from the essence or spirit of this disclosure which can be read from the claims and the entire identification. An information processing apparatus, an information processing method, and a recording medium with such changes are also intended to be within the technical scope of this disclosure. Furthermore, to the extent permitted by law, all publications and papers described herein are hereby incorporated by reference.

To the extent permitted by law, this application claims the benefit of priority based on Japanese application No. 2022-143820, filed Sep. 9, 2022, the entire disclosure of which is hereby incorporated by reference.

### DESCRIPTION OF REFERENCE CODES

1, 2, 3, 4, 5, 6, 7 Information processing apparatus
11, 211 Code output unit
12, 212 Iris information registration unit
213 Alert output unit
214 Face image acquisition unit
221 Biometric information DB
318 Candidate image registration unit
322 Candidate image DB
420 Settlement unit
521 Permission unit
623 Line-of sight information acquisition unit
624 Selection control unit
725 Estimation unit
726 Position control unit
727 Target person related information registration unit

What is claimed is:

1. An information processing apparatus comprising:
at least one memory that is configured to store instructions; and
at least one first processor that is configured to execute the instructions to:
output a target person code to a target person in at least one of a case where face information on the target person is registered and a case where face authentication of the target person is successful; and
register iris information collected from the target person, in association with identification information capable of identifying the target person and the registered face information on the target person, in a case where the target person code is inputted by the target person when registering the iris information on the target person.

2. The information processing apparatus according to claim 1, wherein the at least one first processor is configured to execute the instructions to:
output an alert to the target person in a case where a code that is different from the target person code is inputted by the target person when the iris information is registered; and
not register the iris information on the target person in association with the identification information capable of identifying the target person and the registered face information on the target person, in the case where the code that is different from the target person code is inputted by the target person.

3. The information processing apparatus according to claim 1, wherein the at least one first processor is configured to execute the instructions to:
acquire a face image of the target person generated by imaging a face of the target person to be subjected to the face authentication; and
register the face image as a candidate image for extracting the iris information (1) when the face authentication of the target person is successful, (2) when the iris information on the target person is not registered, and (3) when an iris area of the face image has quality that is higher than or equal to a predetermined quality.

4. The information processing apparatus according to claim 3, wherein the at least one first processor is configured to execute the instructions to:
output a confirmation code to the target person when registering the candidate image; and
extract the iris information from the candidate image and register the iris information in association with the identification information and the face information in a case where the confirmation code is inputted by the target person.

5. The information processing apparatus according to claim 1, wherein the at least one first processor is configured to execute the instructions to perform a settlement when at least one of the face authentication and iris authentication is successful, and perform different operations regarding the settlement between (i) when one of the face authentication and the iris authentication is successful and (ii) when both of the face authentication and the iris authentication are successful.

6. The information processing apparatus according to claim 1, wherein the at least one first processor is configured to execute the instructions to:
permit a first target person having a first role to enter a specific area when both of the face authentication and iris authentication are successful; and
permit a second target person having a second role, who is associated with the first target person, to enter the specific area (a) when the first target person succeeds in both of the face authentication and the iris authentication and (b) when the second target person succeeds in the face authentication.

7. The information processing apparatus according to claim 6, wherein
when permitting at least one of the first target person and the second target person to enter the specific area,
the at least one first processor is configured to execute the instructions to permit a third target person having a third role, who is in a predetermined range including at least one of the first target person and the second target person, to enter the specific area.

8. The information processing apparatus according to claim 1, wherein the at least one first processor is configured to execute the instructions to:
acquire line-of-sight information on the target person to be subjected to iris authentication; and
select any of a plurality of iris imaging units on the basis of the line-of-sight information and control the selected iris imaging unit to image an iris of the target person.

9. The information processing apparatus according to claim 1, wherein the at least one first processor is configured to execute the instructions to:
estimate a target person position of the target person identified by iris authentication, on the basis of the iris information used for the iris authentication;
control imaging to generate an image of an area including the target person position; and
detect a target person related area including at least one of a face area, a clothing area, and a wearing item area of the target person at the target person position in the image, and register target person related information about the target person related area, in association with the registered iris information on the target person.

10. An information processing method comprising:
outputting a target person code to a target person in at least one of a case where face information on the target person is registered and a case where face authentication of the target person is successful; and
registering iris information collected from the target person, in association with identification information capable of identifying the target person and the registered face information on the target person, in a case where the target person code is inputted by the target person when registering the iris information on the target person.

11. A non-transitory recording medium on which a computer program that allows a computer to execute an information processing method is recorded, the information processing method including:
outputting a target person code to a target person in at least one of a case where face information on the target person is registered and a case where face authentication of the target person is successful; and
registering iris information collected from the target person, in association with identification information capable of identifying the target person and the registered face information on the target person, in a case where the target person code is inputted by the target person when registering the iris information on the target person.
